(19) United States
(12) Patent Application Publication
(10) Pub. No.: US 2012/0224663 A1
(43) Pub. Date: Sep. 6, 2012

(54) NUCLEAR STEAM GENERATOR SUPPORT AND ALIGNMENT STRUCTURE

(75) Inventors: Raman (Rajoo) G. Patel, Pittsburgh, PA (US); Daniel L. Walters, Monroeville, PA (US); Arthur W. Francis, Cranberry, PA (US); Christopher F. Herleman, Coraopolis, PA (US); Douglas E. Ekeroth, Delmont, PA (US); Matthew M. Rohr, Belle Vernon, PA (US); Abby L. Stemler, Pittsburgh, PA (US)

(73) Assignee: WESTINGHOUSE ELECTRIC COMPANY LLC., Cranberry Township, PA (US)

(21) Appl. No.: 13/204,091

(22) Filed: Aug. 5, 2011

Related U.S. Application Data
(60) Provisional application No. 61/447,892, filed on Mar. 1, 2011.

(51) Int. Cl. G21C 19/00

(52) U.S. Cl. 376/260

(57) ABSTRACT

A nuclear steam generator support and alignment system that supports the entire weight of a nuclear steam generator on the walls of the shielding compartment in which the steam generator is designed to operate within. The support includes hydraulic positioners that can raise, lower, rotate and tilt the steam generator to align the steam generator with reactor coolant piping to which it is to be connected.

### CROSS REFERENCE TO RELATED APPLICATION

This application claims priority to provisional application Ser. No. 61/447,892, filed Mar. 1, 2011.

### BACKGROUND

1. Field

The embodiments described herein pertain generally to nuclear steam generator supports and more particularly to a nuclear containment support that can raise, lower, tilt and rotate a steam generator to align the steam generator with the reactor coolant piping that is to be welded to during nuclear plant construction.

2. Description of Related Art

The primary side of nuclear reactor power generating systems which are cooled with water under pressure comprise a closed circuit which is isolated and in heat exchange relationship with a secondary circuit for the production of useful energy. The primary side comprises the reactor vessel enclosing a core internal structure that supports a plurality of fuel assemblies containing fissile material, the primary circuit within heat exchange steam generators, the inner volume of the pressurizer, pumps and pipes for circulating pressurized water; the pipes connecting each of the steam generators and pumps to the reactor vessel independently. Each of the parts of the primary side comprising a steam generator, a pump and a system of pipes which are connected to the vessel form a loop of the primary side of the nuclear power generating system.

For the purpose of illustration, FIG. 1 shows a simplified nuclear reactor primary system, including a generally cylindrical reactor pressure vessel 10 having a closure head 12 enclosing a nuclear core 14. A liquid reactor coolant, such as water or borated water, is pumped into the vessel 10 by pump 16 through the core 14 where heat energy is absorbed and is discharged to a heat exchanger 18, typically referred to a steam generator, in which heat is transferred to a utilization circuit (not shown), such as a steam driven turbine generator. The reactor coolant is then returned to the pump 16, completing the primary loop. Typically, a plurality of the above described loops are connected to a single reactor vessel 10 by the reactor coolant piping 20 with one of the primary coolant loops including a pressurizer 22 for regulating the pressure of the primary system.

Each steam generator 18 is a vertical-shell U-tube evaporator with integral moisture separating equipment. The reactor coolant flow enters the steam generator 18 through a single hot leg nozzle 24 before passing into the inverted U-tubes which occupy a substantial portion of the reduced diameter generally cylindrical shell 28, where it transfers heat to the secondary side as it passes through the U-tubes and returns to the cold leg side 26 of the primary coolant piping 20. The flow leaves the steam generator through two cold leg nozzles 30, to each of which a reactor coolant pump 16 is directly attached. The discharge nozzles of the coolant pumps 16 are each connected to a cold leg 26 of the main coolant piping to convey the relatively cool reactor coolant back to the reactor vessel 10 for recirculation through the core 14, where the cycle is repeated. The primary reactor power generating system thus described is an advanced passive nuclear power generating facility known as the AP 1000 plant, designed and sold by the Westinghouse Electric Company LLC, headquartered in Cranberry Township, Pa. During the development of AP 1000 installation procedure, it was recognized that the AP 1000 nuclear plant steam generator has unique features. Previous methods used in erecting legacy steam generators and nuclear plant configurations used spool pieces to join the primary coolant piping to the steam generators and the main coolant pumps were connected to a span of the cold leg of the reactor coolant piping spaced from the steam generators. The prior art steam generators typically had four legged stable supports that supported them from below. The unique features of the AP 1000 nuclear plant design in, for example, having the main coolant pumps directly connected to the bottom of the steam generators required that a different support approach be taken. A single “pogo stick type” pedestal support was designed for this purpose. In addition, the AP 1000 steam generator is designed to be welded to the main coolant piping using no spool pieces, which requires exacting alignment of the main coolant piping with the corresponding nozzles on the steam generators and coolant pumps. Considering that an AP 1000 nuclear plant steam generator weighs approximately 1,463,000 pounds (664 metric tons), a precision alignment device is required during nuclear plant construction to assemble the steam generator in the nuclear plant primary system. Preferably, such an alignment device can support the entire weight of the steam generator assembly to free to the overhead crane typically employed for coarsely positioning the steam generator, for other construction projects.

Thus, it is an object of this embodiment to provide a steam generator alignment fixture that can precisely position and align the steam generator inlet nozzles and pump outlet nozzles with the corresponding primary loop piping.

It is a further object of this embodiment to provide such a fixture that can support the entire weight of the steam generator without the assistance of an overhead crane.

It is an additional object of this embodiment to provide such a fixture that has the ability to raise, lower, rotate and tilt the steam generator into appropriate alignment.

It is an additional object to provide such a fixture that will facilitate the erection of a permanent support for the steam generator.

Further, it is an object of this embodiment to provide such a fixture that can be readily dismantled and reused once a permanent support for the steam generator has been erected.

### SUMMARY

These and other objects are achieved by steam generator support and alignment structure that supports the steam generator from a floor or an internal wall within a nuclear containment. The support and alignment structure described herein comprises a substantially rigid support fixture that extends from the floor or internal wall of a nuclear containment and is attached to at least two sides of the steam generator. The substantially rigid support fixture includes a base, a support section and means for aligning the generator. The base rests on the floor or internal wall of the containment. The support section is coupled to at least a portion of the circumference of a side of the steam generator. The means for aligning the generator is operable to raise, lower or rotate the support section relative to the base with the generator secured within the support section, to align the generator. Preferably, the means for raising, lowering or rotating the support section includes a plurality of hydraulic jacks between the base and the support section, and desirably, the means for so orienting the support section can tilt and laterally move the support section relative to the base while supporting the entire weight of the steam generator assembly while it is being aligned.

In one embodiment, the means for raising, lowering or rotating the support section relative to the base with the steam generator secured within the support section provides for fine movement of the steam generator sufficient to align the steam generator inlet nozzle and one or more steam generator outlet nozzles respectively with the primary coolant piping of a reactor system. Preferably, such fine movement of the steam generator is in as little as 0.03125 inch (0.07938 centimeter) increments.

In another embodiment, the support section comprises an upper support section, connected to an upper cylindrical section of the steam generator, and a lower support section, connected to a lower cylindrical reduced diameter cylindrical section of the steam generator and the means for raising, lowering or rotating the support section relative to the base is connected between the upper support section and the base. Preferably, the lower support section is located below the base and the steam generator dead weight, i.e., weight without water, is substantially supported by the upper support section from at least two substantially diametrically opposed lift links which engage trunnions on the side of the steam generator. Desirably, where the steam generator is at least partially surrounded by an internal containment wall, the upper support section is supported upon at least four points on the wall and preferably a support at each of the at least four points on the wall has at least one lateral hydraulic member for laterally moving the steam generator. Desirably, the at least one lateral hydraulic member comprises two lateral hydraulic members respectively moveable in an X and Y direction. In one embodiment, the upper support section includes a support ring that substantially surrounds a circumference of the upper cylindrical section of the steam generator and each of the lateral hydraulic members respectively engages the support ring to laterally move the support ring and thus the generator when the lateral hydraulic members are activated. Preferably, the support ring supports and engages a plurality of vertical hydraulic members, wherein each of the vertical hydraulic members is positioned adjacent a corresponding lateral hydraulic member. Desirably, each of the vertical hydraulic members engage and support a support frame which is engaged with each steam generator lift link.

In still another embodiment, the lower support section is braced against at least two diametrically opposed points on an inside of the internal containment wall in a manner that will permit the steam generator to rotate and move up, down and laterally a given distance, but limit the side-to-side movement of the steam generator. Preferably, the lower support section includes lateral hydraulic extension arms that brace against the inside of the internal containment wall. Desirably, the lateral hydraulic extension arms retract towards the steam generator so that the steam generator can be initially positioned within the internal wall.

In a further embodiment, the means for raising, lowering or rotating the support section relative to the base comprises a plurality of hydraulic members and preferably some of the hydraulic members act in combination with a bearing plate or roller support to effect movement of the steam generator.

### BRIEF DESCRIPTION OF THE DRAWINGS

A further understanding of the invention can be gained from the following description of the preferred embodiments when read in conjunction with the accompanying drawings in which:

FIG. 1 is a simplified perspective view of nuclear reactor primary system to which this embodiment can be applied;

FIG. 2A is a perspective view of the upper support section of one embodiment described herein with a steam generator shown in phantom supported within a containment cubicle;

FIG. 2B is another perspective view of the upper support section shown in FIG. 2A;

FIG. 3 is an enlarged view of the upper support section shown in FIG. 2;

FIG. 4 is an enlarged perspective view of a wall support saddle and associated hydraulic mechanisms of the upper support section shown in FIGS. 2 and 3;

FIG. 5 is another perspective view of the wall support saddle shown in FIG. 4;

FIG. 6 is a plan view of the upper support section shown in FIGS. 2 through 5;

FIG. 7A is a schematic view of the lower support of the embodiment described herein circumscribing a lower portion of the shell of a steam generator, shown in phantom, with the lower support in a retracted position;

FIG. 7B is a schematic view of the support shown in FIG. 7A with the laterally extending arms deployed;

FIG. 7C is a perspective view of FIG. 7B with the steam generator slightly rotated to better show the extending member deployed;

FIG. 8 is an isometric view of the lower support shown in FIG. 7;

FIG. 9 is a plan view of another embodiment of the upper support employing Hillman rollers to effect rotation of the steam generator;

FIG. 10 is a schematic side view of the embodiment illustrated in FIG. 9;

FIG. 11 is a side view partially in section of another embodiment of the lower support described herein; and

FIG. 12 is an isometric view of an operator control station that can be employed with the embodiments illustrated in FIGS. 2-11.

### DESCRIPTION OF THE PREFERRED EMBODIMENT

The lower portion of a nuclear steam generator that contains the primary side of the reactor coolant loop is typically shielded by a concrete cubicle in which the steam generator is supported. The embodiments described herein provide a temporary installation and alignment tool for supporting the steam generator within its concrete shielding in the course of construction of a nuclear power plant that enables the steam generator to be raised, lowered, rotated and tilted so it can be aligned with the connecting reactor coolant piping and the erection of a permanent steam generator support. While the support and alignment fixture described herein can be used as a permanent steam generator support, it serves more value as a temporary support during construction where it can be moved from generator to generator to facilitate the attachment of each of the steam generators to the reactor primary coolant system. The support fixture described herein uses structural steel support framing and hydraulic jacking and control monitoring devices to lift, jack, laterally move, tilt and rotate a steam generator during its installation process.

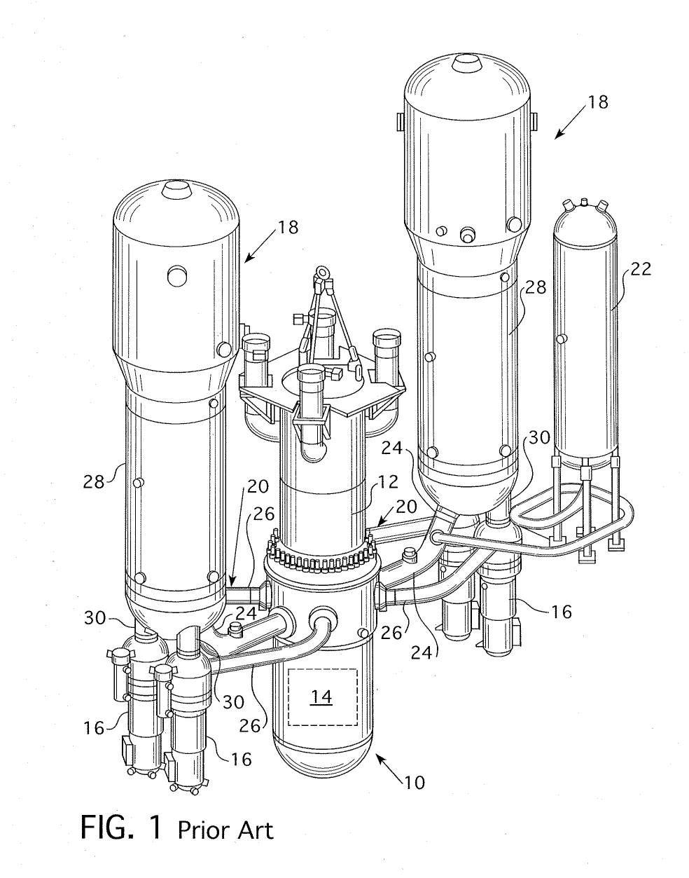

Previous nuclear steam generators required stable base supports to be installed prior to setting the generators in position. The steam generators were fastened to the base supports and became self-supporting. Such a support is not practical for the type of steam generator illustrated in FIG. 1, which has two main coolant pumps extending vertically from its lower end.

The embodiments described herein are unique in that they stabilize and support the entire weight of the steam generator after the steam generator is initially situated within its shielding compartment and maneuver the steam generator into alignment with the coolant piping to which it is to be welded. Thus, the embodiments set forth herein permit the overhead crane to be disengaged from the steam generator so that it is available for other construction work. Accordingly, the support fixtures described herein enable the setting of an unbalanced steam generator which has two reactor coolant pump casings welded on the bottom end of the steam generator, while supporting and enabling movement of the loaded steam generator in three directions and installation of permanent upper, lower and intermediate lateral supports and snubbers.

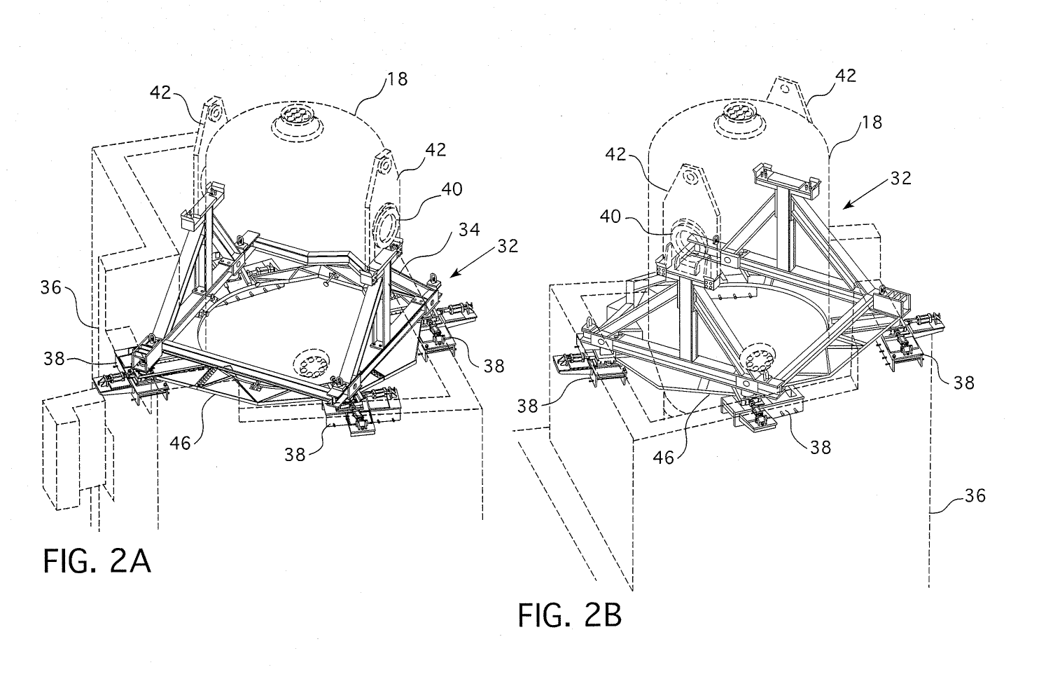

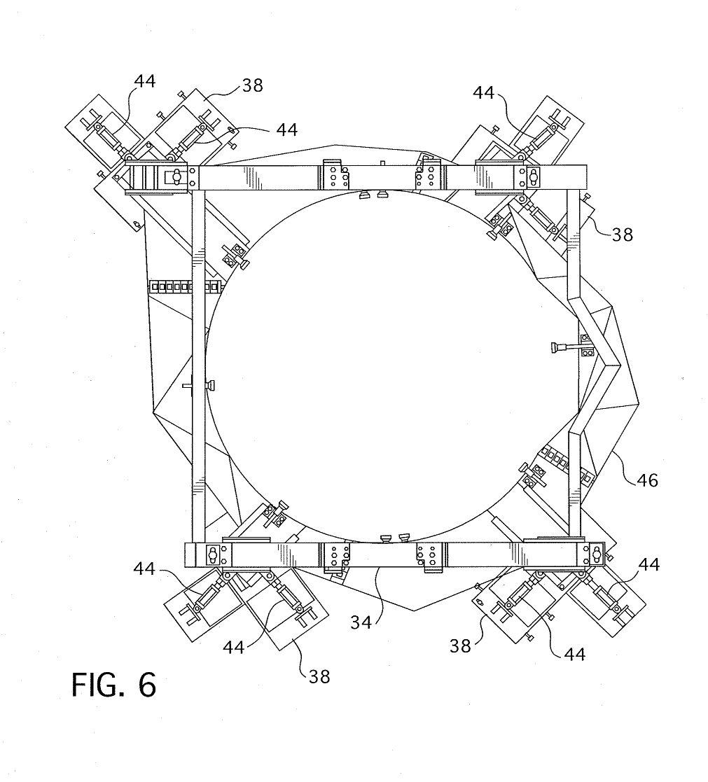

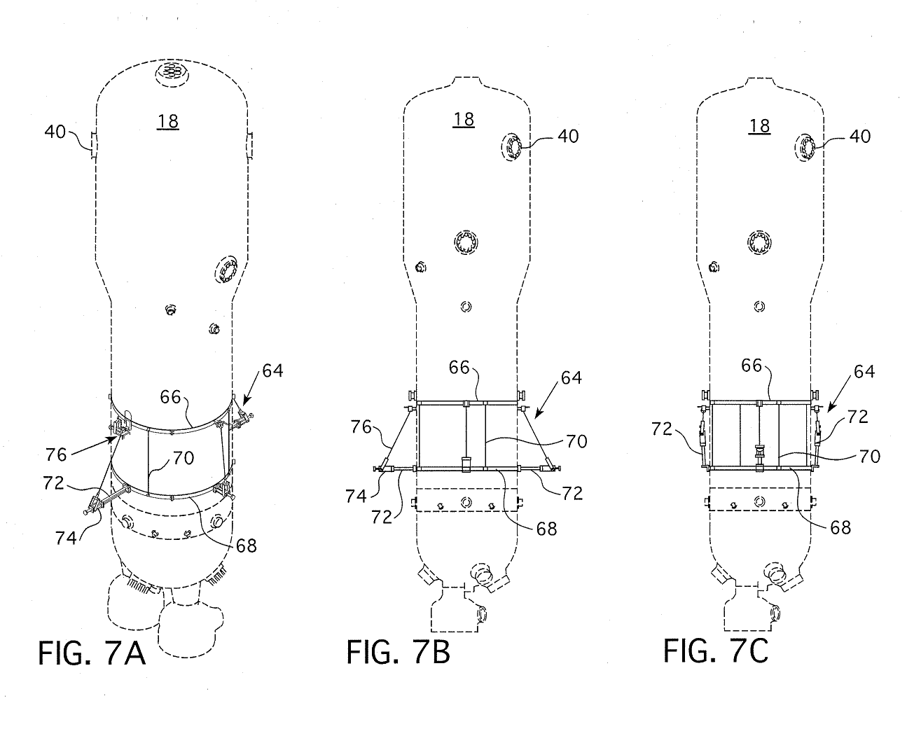

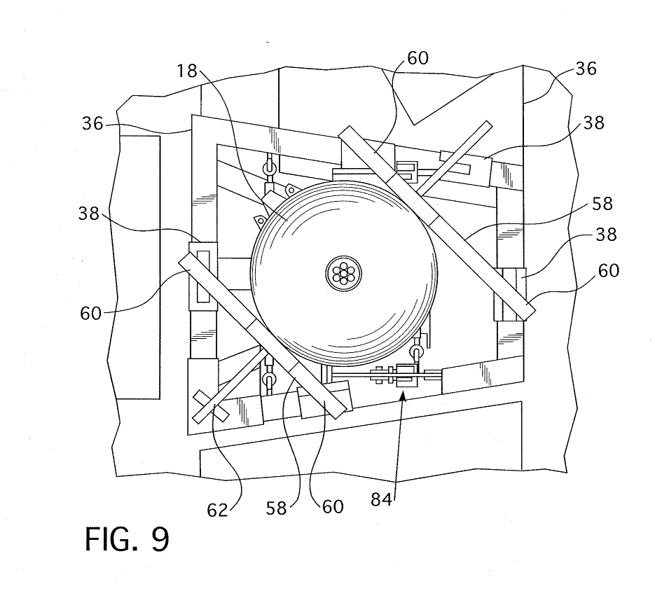

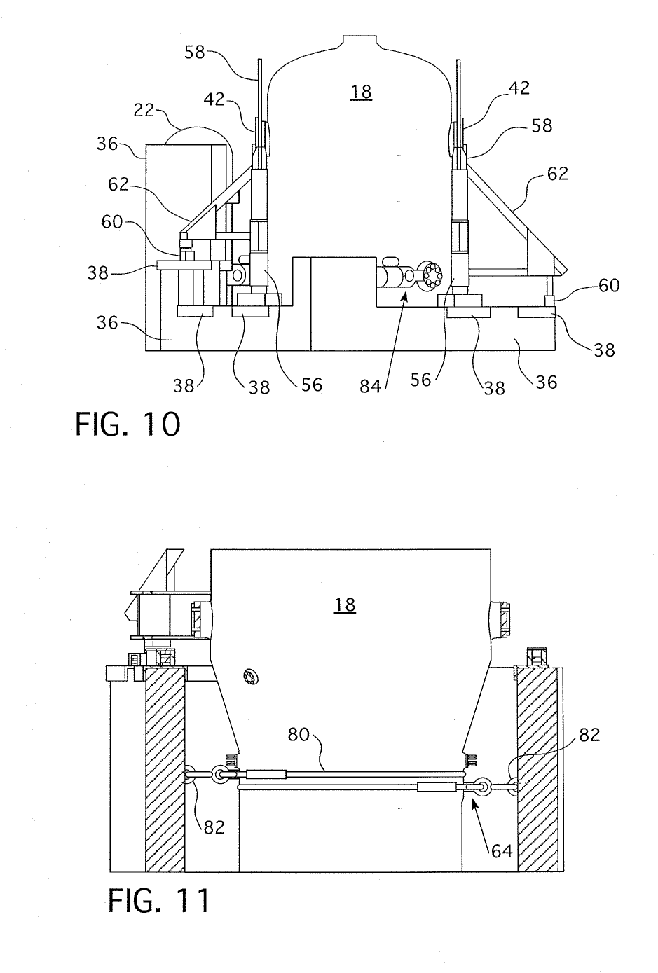

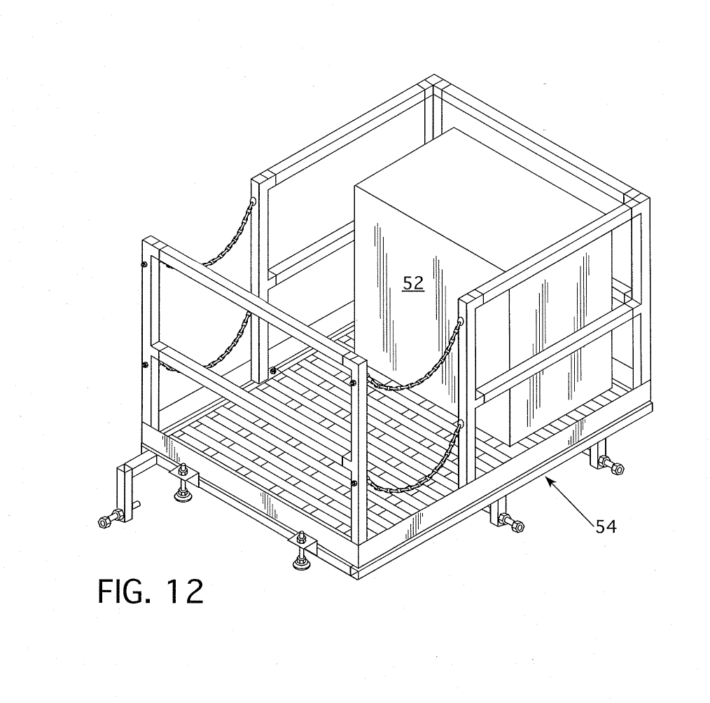

While the alignment fixture of the embodiments described herein are illustrated as being applied to an AP 1000 nuclear plant, and more particularly an AP 1000 nuclear steam generator, it should be appreciated that the principles described herein can be applied to most any tube and shell steam generator design. One embodiment of the alignment and support fixture claimed hereafter is disclosed in FIGS. 2-8, with an upper support frame of the fixture illustrated in FIGS. 2-6. In this embodiment, as illustrated in FIGS. 2A and 2B, the upper support frame 34 of the support fixture 32 is located on top of the concrete walls 36 that surround the lower portion of the steam generator 18. The lower portion of the steam generator can be temporarily or permanently supported within the compartment's walls 36 in a variety of ways as illustrated, for example, in FIGS. 7, 8 and 11, as will be described hereinafter. A second embodiment of the upper support 34 is illustrated in FIGS. 9 and 10.

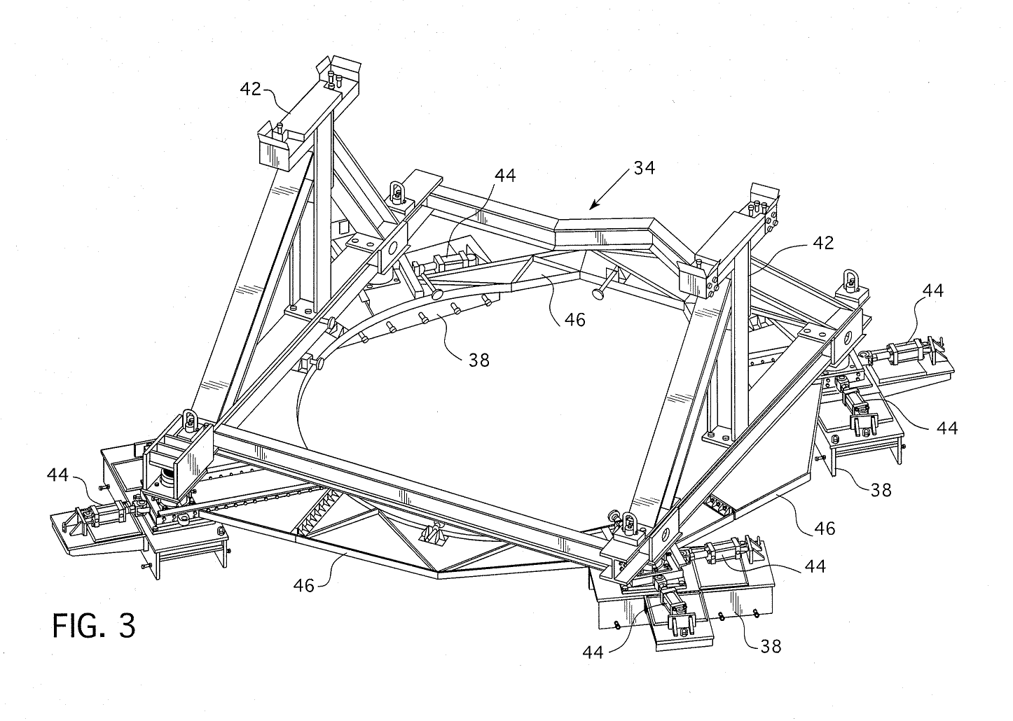

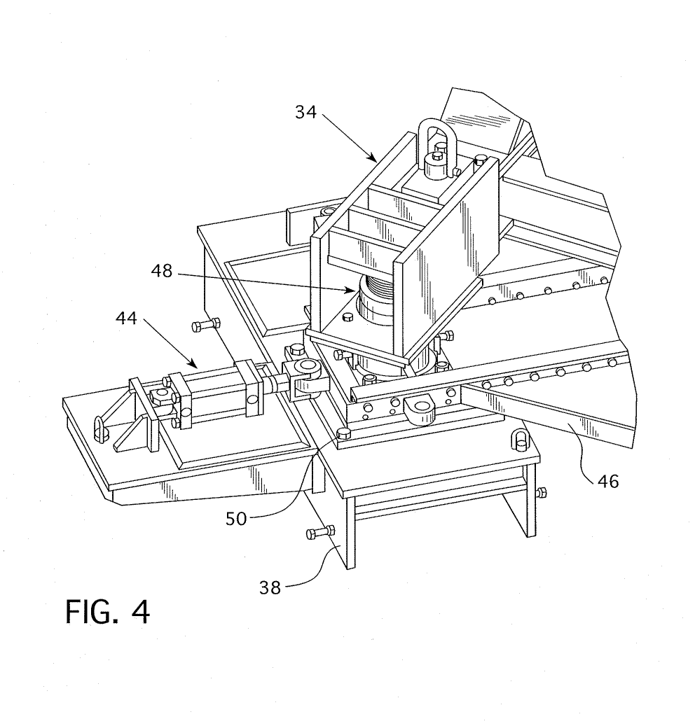

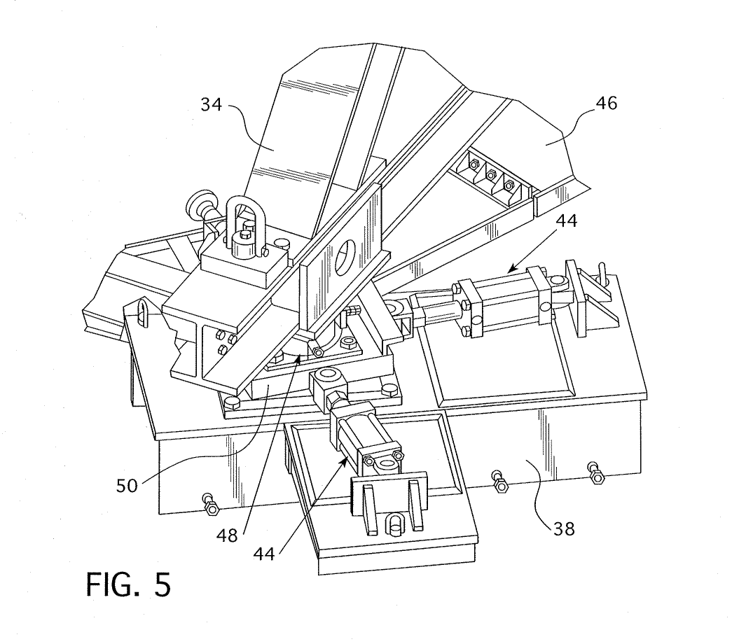

As shown in FIG. 2, the upper support frame 34 is formed from a structural steel frame that surrounds the generator and rests on four spaced shoes 38 that respectively rest on the top of the concrete walls 36 that surround the lower portion of the steam generator 18. As shown in FIGS. 2A and 2B, the steam generator bearing load is supported on two secondary manway lift trunnions 40, by a lift link 42 which extends vertically from diametrically opposite sides of the support frame 34. Each saddle 38 that supports the upper support frame 34 on the concrete walls 36, engages at least one lateral hydraulic member, and preferably two such hydraulic members 44 as shown in FIGS. 3-6. Each lateral hydraulic member 44 is respectively attached or otherwise engaged with support ring 46 that encircles at least a portion of the steam generator 18. The support ring 46 may be a single component or comprise multiple members. The support ring 46 supports or otherwise engages multiple vertical hydraulic members 48 which are each positioned between a saddle 38 and the upper support frame 34. In the embodiments shown in FIGS. 2-6, the support ring 46 supports four vertical hydraulic members 48, one at each of the saddle locations approximately evenly spaced around the support ring 46 and is engaged respectively with two lateral hydraulic members respectively oriented in the X and Y planes. It can be appreciated best from FIGS. 4 and 5, that the vertical hydraulic members 48 are respectively mounted on a lubron bearing translation pad 50 which is affixed to a corresponding wall saddle 38 and is in turn connected to each lateral hydraulic member 44. Another end of vertical hydraulic member 48 is connected to the upper support frame 34 and the radial inward portion of the lubron bearing 50 is connected to the support ring 46. The vertical hydraulic members engage and support the upper support frame 34 which in turn engages and supports the steam generator lift link 42.

The steam generator temporary support upper support frame 42 thus described is supported by the cubicle walls 36 at an elevation of approximately 153 feet above the operating floor of the containment and has a relatively small operator platform 54 and control box 52 for controlling the operation of the various hydraulic members. The vertical hydraulic members enable up and down movement of the steam generator up to approximately six inches (15.24 centimeters) in 1/32 inch (0.08 centimeters) increments. Similarly, the lateral hydraulic members enable lateral and transverse movement of the steam generator up to six inches (15.24 centimeters) in 1/32 inch (0.08 centimeters) increments. The system of this embodiment also enables correction of the steam generator vertical axis by 0.50 degrees. Control of the several hydraulic members can be had from the control unit 52 which can be accessed on the control platform 54 which is temporarily cantilevered from the top of the concrete walls 36 that surround the generator 18.

As an alternate to the system illustrated in FIGS. 2 through 6, described above, the positioning and alignment system of this application may utilize a jacking mechanism such as the Enerpac® (or equivalent) single acting hydraulic jacks 56 which are connected to the support members 58 which carry the support links 42 which support the steam generator trunnions 40. In the embodiment illustrated in FIGS. 9 and 10, Hillman Swivel OT rollers (or equivalent) 60 are employed with a synchronized master control unit 52. Similarly, the GenMover “MUSE” moving system may be employed. In FIGS. 9 and 10, the Hillman rollers 60 are supported from the support members 58 by the support links 62. The support and alignment system described herein may have a single control unit 52 or be operated remotely by a technician. The control system is universal and may be interchangeable between multiple steam generators connected to the same reactor. The control system includes all of the hydraulic power units, hydraulic plumbing lines and control valves. The hydraulic jacks 56 are preferably single acting with mechanical locking devices for safety. An Enerpac® PV-42 (or equivalent) control or monitoring device may be employed with such a system.

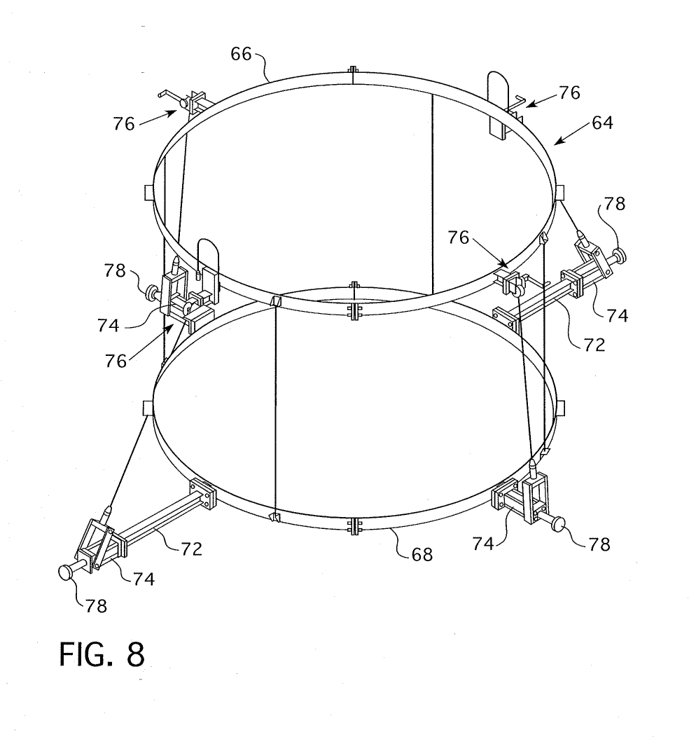

In operation, the embodiments illustrated in FIGS. 2-6 may function as follows. An overhead crane or outside heavy duty mobile crane can transport and position a steam generator adjacent to the cubicle walls in which the generator is to be situated. The crane generally performs this function by engaging the trunnions 40. The crane will lower the steam generator into the void area surrounded by the cubicle module walls 36 and over a vertical column support (“pogo stick”). As the steam generator 18 is lowered by the crane, each trunnion respectively engages a lift link 42 on the upper support frame 34. Upon the support frame engaging the steam generator 18, via the lift link 42 and the lower restraint, for example, as illustrated in FIGS. 7 and 8, being secured, the hydraulic members connected to the upper support frame 34 may be utilized to maneuver the steam generator into the desired position in alignment with the primary coolant piping. In this regard, the vertical hydraulic members 48 may be activated to lower or raise the steam generator 18. As previously mentioned, the vertical hydraulic members 48 support the upper support frame 34 and are attached to the support ring 46. The lateral hydraulic members 44 may then be activated to maneuver the steam generator in the X-Y direction. In the exemplary embodiment shown in FIGS. 2-6, each lateral hydraulic member 44 is positioned adjacent and connected to a saddle 38 and each of the saddles are connected to the support ring 46 at circumferentially spaced locations. The lateral hydraulic member 44 can thus force the support ring 46 to change position. Forcing the support ring 46 to change position as a result of the activation of the lateral hydraulic member 44 causes the upper support frame to change position in an X-Y plane. In the embodiment shown, the support ring is engaged with the steam generator 18 by way of toggles, and with the saddle 38 by way of the lubron bearings 50. Any suitable device may be used for these connections. The toggles and lubron bearings 50 respectively cause the support ring to be movable attached to the steam generator 18 and the saddle 38.

Two exemplary, alternate lower restraint assemblies are shown in FIGS. 7, 8 and 11. Other similar restraints may also be used. In the embodiment shown in FIGS. 7 and 8, the lower restraint 64 comprises an upper band 66 and a lower band 68. Both bands are respectively fixed to a lower section of the steam generator 18 in an area where the primary coolant flows within U-tubes within the steam generator housing. The upper band 66 and the lower band 68 are engaged with each other by a plurality of vertically connecting members 70. A plurality of spaced extension arms 72 with hydraulic jack systems 74 respectively at their distal ends extend radially from and are at spaced locations around the lower band 68. The extension aims 72 are preferably pivotably connected to the lower band 68. Multiple winches 76 are respectively attached at various spaced locations on the circumference of the upper band 66 vertically aligned with the extension arm 72 for up righting the hydraulic jack system 74 at the distal end of the extension arm 72. Aligned extension arms 72 and winches 76 are respectively engaged with each other via a wire cable. The winches 76 are utilized to raise and lower the extension aims 72 to enable the extension arms to radially retract against the steam generator housing so that the steam generator 18 can be lowered within the concrete walls 36 of a shielding cubicle. The winches 76 can then lower the extension arm 72 so the hydraulic jack systems 74 can be extended to engage the module walls 36 and brace the lower portion of the generator 18 against the cubicle module walls. A pad 78 is positioned at the end of each extension 72. The pad 78 engages the module walls 36 during deployment of the lower restraint assembly. FIG. 7A shows the lower restraint assembly with the extension arms 72 in the retracted position so that the generator can be lowered into its concrete walled cubicle that ultimately shields the generator. FIG. 7B shows the winch cables fully extended and the extension aims 72 lowered for the deployment of the hydraulic jack 74 at their distal end. FIG. 7C shows a similar view with the extension alms 72 fully extended with the generator slightly rotated from the view shown in FIGS. 7B and provides another perspective of an extended extension arm 72 and corresponding winch 76. An alternate lower restraint 64 is shown in FIG. 11 in which the steam generator 18 is tied down to the concrete walls 36 employing a cable 80 and anchors 82.

An upper lateral support with a snubber 84 may also be used to engage the steam generator 18 to the concrete walls 36 as shown in FIGS. 9 and 10. As previously mentioned with regard to the alternate embodiment of the upper support previously described with regard to FIGS. 9 and 10, the hydraulic jacks 56 may raise or lower the steam generator by raising or lowering the support members 58 and support links 62. The hydraulic jack 56 may also remove any load from the Hillman rollers 60 thereby allowing the Hillman rollers to be rotated to a different position. Lateral hydraulic actuators may also be used in this embodiment, as previously described with regard to the embodiment illustrated in FIGS. 2-6, to force the support link 62 and support member 58 to move in various directions. The hydraulics are controlled by a computer system that synchronizes their actions to simultaneously cause the desired movement. The control system can also function to synchronize the hydraulic jacks 74 on the lower restraint 64 with the upper restraint 34.

While specific embodiments of the invention have been described in detail, it will be appreciated by those skilled in the art that various modifications and alternatives to those details could be developed in light of the overall teachings of the disclosure. For example, pneumatic cylinders may be employed in place of the hydraulic cylinders. Accordingly, the particular embodiments disclosed are meant to be illustrative only and not limiting as to the scope of the invention which is to be given the full breadth of the appended claims and any and all equivalents thereof.

What is claimed is:

1. A nuclear steam generator support and alignment structure for supporting a steam generator from a floor or an internal wall of a nuclear containment comprising;
a substantially rigid support fixture extending from the floor or internal wall of the nuclear containment and attached to at least two sides of the steam generator to freely support the steam generator, the substantially rigid support fixture including;
a base resting on the floor or internal wall;
a support section coupled to at least a portion of a circumference of a side of the steam generator; and
means for raising, lowering or rotating the support section relative to the base with the steam generator secured within the support section.

2. The nuclear steam generator support and alignment structure of claim 1 wherein the means for raising, lowering or rotating the support section includes a plurality of hydraulic jacks between the base and the support section.

3. The nuclear steam generator support and alignment structure of claim 1 wherein the means for raising, lowering or rotating the support section also can tilt and laterally move the support section relative to the base with the steam generator secured within the support section.

4. The nuclear steam generator support and alignment structure of claim 1 that supports the entire weight of the steam generator while it is aligning the steam generator for attachment to a reactor coolant system.

5. The nuclear steam generator support and alignment structure of claim 4 that supports the entire weight of the steam generator and one or more coolant pumps associated therewith while the steam generator is aligning with the reactor coolant system.

6. The nuclear steam generator support and alignment structure of claim 1 wherein the means for raising, lowering or rotating the support section relative to the base with the steam generator secured within the support section provides for fine movement of the steam generator sufficient to align a steam generator inlet nozzle and one or more steam generator outlet nozzles with a primary coolant loop piping of a reactor system.

7. The nuclear steam generator support and alignment structure of claim 6 wherein the means for raising, lowering or rotating the support section relative to the base with the steam generator secured within the support section provides for fine movement of the steam generator in as little as 0.03125 inch (0.07938 cm) increments.

8. The nuclear steam generator support and alignment structure of claim 1 wherein the steam generator includes a lower cylindrical reduced diameter section, an upper cylindrical section having a diameter larger than the reduced diameter section and a frustoconical section connecting the lower reduced diameter section to the enlarged diameter upper cylindrical section and the support section comprises an upper support section connected to the upper cylindrical section and a lower support section connected to the lower cylindrical reduced diameter section.

9. The nuclear steam generator support and alignment structure of claim 8 wherein the means for raising, lowering or rotating the support section relative to the base is connected between the upper support section and the base.

10. The nuclear steam generator support and alignment structure of claim 9 wherein the lower support section is located below the base.

11. The nuclear steam generator support and alignment structure of claim 8 wherein a steam generator bearing load is substantially supported by the upper support section from at least two substantially diametrically opposed lift links on the side of the steam generator.

12. The nuclear steam generator support and alignment structure of claim 11 wherein the steam generator is at least partially surrounded by the internal wall and the upper support section is supported upon at least four points on the wall.

13. The nuclear steam generator support and alignment structure of claim 12 wherein a support at each of the at least four points on the wall has at least one lateral hydraulic member for laterally moving the steam generator.

14. The nuclear steam generator support and alignment structure of claim 13 wherein the at least one lateral hydraulic member comprises two lateral hydraulic members respectively moveable in an X and Y direction.

15. The nuclear steam generator support and alignment structure of claim 13 wherein the upper support section includes a support ring that substantially surrounds a circumference of the upper cylindrical section of the steam generator and each of the lateral hydraulic members respectively engages the support ring to laterally move the support ring and thus the steam generator when the lateral hydraulic members are activated.

16. The nuclear steam generator support and alignment structure of claim 15 wherein the support ring supports and engages a plurality of vertical hydraulic members, wherein each of the vertical hydraulic members is positioned adjacent a corresponding lateral hydraulic member.

17. The nuclear steam generator support and alignment structure of claim 16 wherein each of the vertical hydraulic members engage and support a support frame which is engaged with each steam generator lift link.

18. The nuclear steam generator support and alignment structure of claim 12 wherein the lower support section is braced against at least two diametrically opposed points on an inside of the internal wall in a manner that will permit the steam generator to rotate and move up, down and laterally a given distance, but limit a side to side movement of the steam generator.

19. The nuclear steam generator support and alignment structure of claim 18 wherein the lower support section includes lateral hydraulic extension arms that brace against the inside of the internal wall.

20. The nuclear steam generator support and alignment structure of claim 19 wherein an end of the lateral hydraulic extension arms retract towards the steam generator so the steam generator can be initially positioned within the internal wall.

21. The nuclear steam generator support and alignment structure of claim 1 wherein the means for raising, lowering or rotating the support section relative to the base comprises a plurality of hydraulic members.

22. The nuclear steam generator support and alignment structure of claim 21 wherein at least some of the hydraulic members act in combination with a bearing plate or roller support to affect movement of the steam generator.

23. The nuclear steam generator support and alignment structure of claim 21 wherein the hydraulic members can tilt the support section and the steam generator when supported within the support section.
